(19) United States
(12) Patent Application Publication
(10) Pub. No.: US 2015/0294434 A1
(43) Pub. Date: Oct. 15, 2015

(54) MXM GRAPHICS CARD ADAPTER

(71) Applicant: LEAP Computing, Inc., Austin, TX (US)

(72) Inventor: Frank Joshua Alexander Nataros, Austin, TX (US)

(21) Appl. No.: 14/682,374

(22) Filed: Apr. 9, 2015

Related U.S. Application Data
(60) Provisional application No. 61/977,212, filed on Apr. 9, 2014.
(60) Provisional application No. 61/977,205, filed on Apr. 9, 2014.

(51) Int. Cl. G06T 1/20; G06F 13/40; G06F 13/42

(52) U.S. Cl. CPC G06T 1/20; G06F 13/4221; G06F 13/4022

(57) ABSTRACT

A graphics card adapter that includes a printed circuit board (PCB) having a PCI Express (PCI-E) interface for transferring graphics information via a PCI-E bus, and a plurality of MXM connectors coupled to the PCB for matingly engaging with graphics cards having a corresponding MXM interface. The graphics card adapter further includes a switch arranged on the PCB which configures a graphics bus between the switch and each of the graphics cards via the corresponding MXM interface, wherein each of the graphics bus is configured to have a substantially equal bandwidth, and wherein the switch multiplexes the PCI-E bus between each of the graphics busses.

### CROSS-REFERENCE TO RELATED APPLICATIONS

The present application claims priority to U.S. Provisional Application No. 61/977,212, titled “Multiple Graphics Adapter for Computing Device” and filed Apr. 9, 2014, and additionally claims priority to U.S. Provisional Application No. 61/977,205, titled “Expansion Chassis for a Computing Device” and filed Apr. 9, 2014.

### TECHNICAL FIELD

The present disclosure relates to a graphics card adapter and, in particular, one configured to receive a plurality of graphics cards having MXM connectors and multiplex a PCI-express bus thereto.

### BACKGROUND

In today's world, technology quickly evolves and advances, and such is a double-edged sword. As technology advances, graphics intensive software and gaming benefit therefrom and begin to require greater storage, memory, and processing power, thus again requiring more advanced technology, and the cycle continues.

With regards to graphics processing, most systems, both desktop and mobile, employ a graphics card when running a game or graphics processing intensive software (e.g., Adobe Photoshop). Such is because the graphics card includes one or more specially designed processors (also called graphics processing units (GPUs)) and increased memory to handle such computationally intensive graphics processing tasks. The graphics processing is substantially or entirely offloaded from the central processor unit (CPU) of the computer, processed by the graphics card, and then the processed graphics are returned to the computer for display. Alternatively, some graphics cards have a display port for direct display of the processed graphics. However, a problem is presented when a user desires expansion of their graphics processing resources.

In a desktop or server system, there are a variety of methods that may be employed to expand graphics processing resources. For example, a current graphics card may be exchanged for a newer graphics card which employs a faster processor and/or an expanded quantity of memory. Alternatively, if the computer had additional graphics bus slots (typically a PCI-Express (PCI-E) bus due to its high bandwidth ability), additional graphics processing cards may be installed.

However, having one or more graphics cards brings inherent downsides as well. For example, higher performance processors require more power and also generate more heat. Thus, aside from the large size of the graphics card already, the heat sync size is necessarily increased and the graphics card consume more space within the chassis. This may be especially problematic in a server or blade server setting, where there is a shortage of physical space available for consumption. Additionally, eventually, the number of graphics slots (e.g., PCI-E slots) will be full, thus limiting expansion without upgrading the motherboard. Lastly, graphics cards, especially new and high end ones, can be very costly.

One current solution to the issue of having a limited number of graphics card slots is expanding the bus via cables or chords running between chassis. However, this fails to alleviate many of the previously discussed problems, such as space requirements and cost. In fact, such expansion chasses and chords are known to be very expensive, manual configuration of such is time intensive, and software configuration of such can be complicated.

Portable computing devices such as laptops, iPads, etc. may be configured similar to desktop and server computers in that they may include a mobile graphics card for handling intense graphics processing. While mobile graphics cards typically have a slightly slower processor, advantageously, such mobile graphics cards for portable devices are smaller in form-factor and typically require less power than those manufactured for desktops and servers. Thus, it would be advantageous to employ a solution enabling mobile graphics cards within a desktop or server environment. However, such is not currently available due to at least the issue of mobile graphics cards having an MXM connector and thus not capable of natively mating with the PCI-E connector employed by desktop and server motherboards. Moreover, if multiple mobile graphics cards are desired, multiplexing the PCI-E bus would be required.

Accordingly, an improved graphics card adapter capable of enabling a plurality of mobile graphics cards to be employed within a PCI-E interface remains highly desirable.

### SUMMARY OF THE INVENTION

It is an object of the present disclosure to provide a graphics card adapter that includes a printed circuit board (PCB) having a PCI Express (PCI-E) interface for transferring graphics information via a PCI-E bus, and a plurality of MXM connectors coupled to the PCB for matingly engaging with graphics cards having a corresponding MXM interface. The graphics card adapter further includes a switch arranged on the PCB which configures a graphics bus between the switch and each of the graphics cards via the corresponding MXM interface, wherein each of the graphics bus is configured to have a substantially equal bandwidth, and wherein the switch multiplexes the PCI-E bus between each of the graphics busses.

It is another object of the present disclosure to provide a method for processing graphics data that includes receiving a first graphics data from a computer with a graphics card adapter via a PCI Express (PCI-E) bus, the graphics card adapter including a printed circuit board (PCB) having a PCI-E interface for transferring graphics data via the PCI-E bus, a plurality of MXM connectors coupled to the PCB for matingly engaging with graphics cards having a corresponding MXM interface, and a switch arranged on the PCB which configures a graphics bus between the switch and each of the graphics cards via the corresponding MXM interface. The method further includes configuring, with the switch, each of the graphics bus to have a substantially equal bandwidth, multiplexing the PCI-E bus between each of the graphics busses with the switch, and sending a second graphics data from the graphics card adapter to the computer via the PCI-E bus.

It is a further object of the present disclosure to provide a graphics data processing system which includes a computer having a PCI-E bus for transmitting graphics data and a graphics card adapter coupled to the computer. The graphics card adapter includes a printed circuit board (PCB) having a PCI Express (PCI-E) interface for transferring graphics information via the PCI-E bus, a plurality of MXM connectors coupled to the PCB for matingly engaging with graphics cards having a corresponding MXM interface. The graphics card adapter further includes a switch arranged on the PCB which configures a graphics bus between the switch and each of the graphics cards via the corresponding MXM interface, wherein each of the graphics bus is configured to have a substantially equal bandwidth, and wherein the switch multiplexes the PCI-E bus between each of the graphics busses.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 is an angled view of a system having a graphics card adapter configured for operation within a host computer, according to one or more embodiments.

FIG. 2 is an enlarged schematic view of a graphics card adapter, according to one or more embodiments.

FIG. 3 is an angled view of the graphics card adapter having graphics cards in various positions during the process of matingly engaging with the MXM connectors, according to one or more embodiments.

FIG. 4 depicts an angled view of a graphics card adapter having MXM connectors arranged such that the graphics cards are arranged substantially perpendicular to the graphics card adapter, according to one or more embodiments.

FIG. 5 is a flow diagram of an illustrative method for processing graphics data via a graphics card adapter, according to one or more embodiments.

### DETAILED DESCRIPTION

The present disclosure relates to a graphics card adapter and, in particular, one configured to receive a plurality of graphics cards having MXM connectors and multiplex a PCI-express bus thereto.

As used herein, a “processor” and/or “graphics processing unit” (GPU) may be comprised of, for example and without limitation, one or more processors (each processor having one or more cores), microprocessors, field programmable gate arrays (FPGA's), application specific integrated circuits (ASICs) or other types of processing units that may interpret and execute instructions as known to those skilled in the art.

As used herein, “memory” may be any type of storage or memory known to those skilled in the art capable of storing data and/or executable instructions. Memory may include volatile memory (e.g., RAM), non-volatile memory (e.g., hard-drives), or a combination thereof. Examples of such include, without limitation, all variations of non-transitory computer-readable hard disk drives, inclusive of solid-state drives. Further examples of such may include RAM external to a computer or controller or internal thereto (e.g., “on-board memory”). Example embodiments of RAM may include, without limitation, volatile or non-volatile memory, DDR memory, Flash Memory, EPROM, ROM, or various other forms, or any combination thereof generally known as memory or RAM. The RAM, hard drive, and/or controller may work in combination to store and/or execute instructions.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

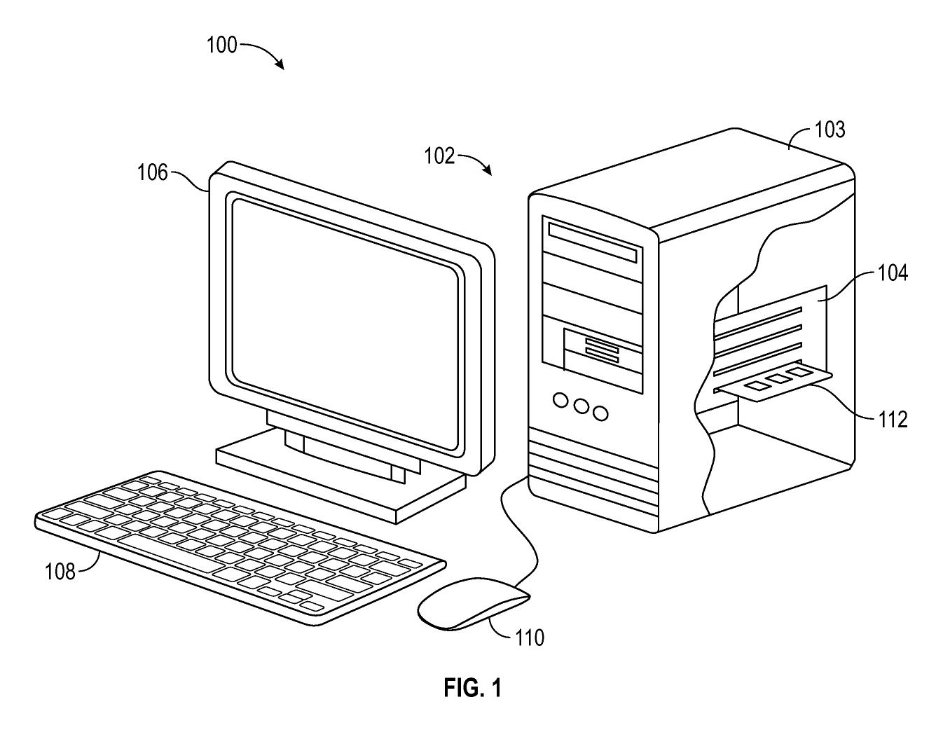

FIG. 1 is an angled view of a system 100 having a graphics card adapter 112 configured for operating within a host computer 102, according to one or more embodiments. As depicted, the system 100 generally illustrates the host computer 102 (or general computing device) which includes a motherboard 104 arranged within a chassis 103. The host computer 102 further includes various peripheral devices, such as a monitor 106, keyboard 108, and mouse 110, which are communicably coupled to the motherboard 104. The motherboard 104 includes a central processing unit (CPU) (not shown), various forms of volatile and non-volatile memory (not shown), and multiple PCI and PCI-Express (PCI-E) slots for additional devices to be communicably coupled to the motherboard 104, thereby enabling increased functionality to the overall system 100.

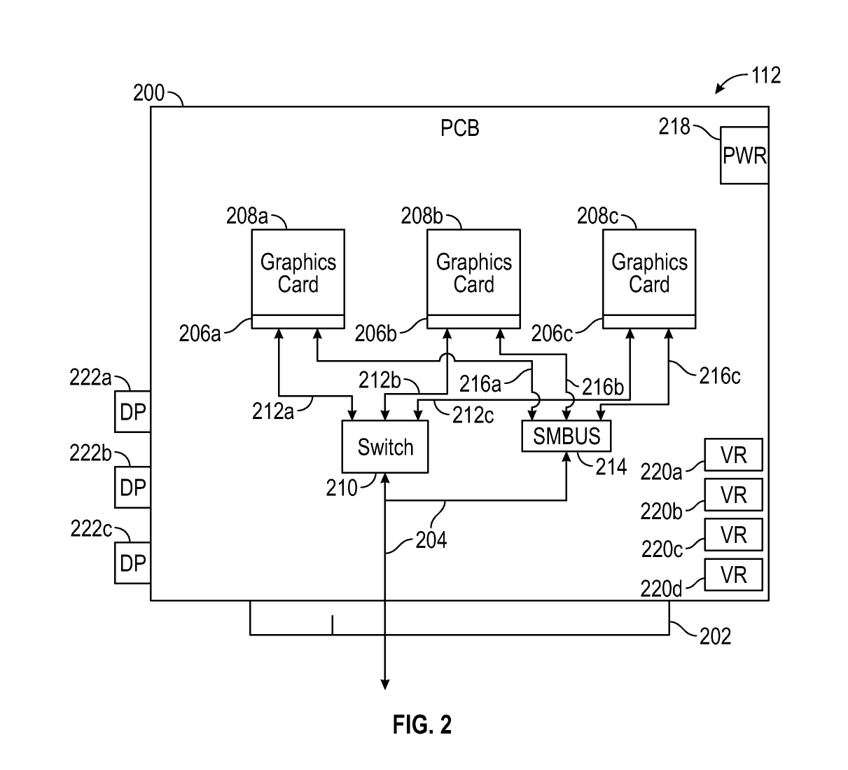

As depicted, the graphics card adapter 112 is inserted into one of the PCI-E slots of the motherboard 104, thereby receiving power from the motherboard 104 and data from the host computer 102. Discussed in further detail in FIG. 2, the graphics card adapter 112 enables use of other graphics cards that employ MXM connectors, typically mobile graphics cards, and enables operation via the PCI-E bus of the motherboard 104 and host computer 102. Therefore, the graphics card adapter 112 is capable of offloading and handling graphics data processing requests or calls from programs running on the host computer 102 and processing such requests with the graphics cards.

It will be appreciated to those skilled in the art that, while a desktop computer system 100 and computer 102 are depicted, any variety of computer is contemplated herein, including but not limited to, a general computing device or desktop, a general server, and/or blade server.

FIG. 2 is an enlarged schematic view of the graphics card adapter 112, according to one or more embodiments. FIG. 2, as depicted, includes a graphics card adapter 112 which comprises a printed circuit board (PCB) 200 having a PCI-Express (PCI-E) interface 202 for transferring graphics information via a PCI-E bus 204. For example, the PCI-E interface 202 may be matingly engaged with a corresponding PCI-E interface on the motherboard 104 of the host computer 102.

The PCB 200 includes a plurality of MXM connectors 206 coupled thereto for matingly engaging with a corresponding MXM interface of graphics cards 208. More specifically, in some embodiments and as depicted, a first MXM connector 206a is matingly engaged with a first graphics card 208a, a second MXM connector 206b is matingly engaged with a second graphics card 208b, and a third MXM connector 206c is matingly engaged with a third graphics card 208c. However, it should be appreciated that in other embodiments, the PCB 200 may include more or fewer than three MXM connectors 206, and thus support more or fewer than three graphics cards 208, accordingly. Moreover, the graphics card adapter 112 has the ability to continue functioning properly even if there are open MXM connectors 206 (e.g., three MXM connectors 206, but only two of them have graphics cards 208 matingly engaged therewith). In some embodiments, such matingly engagement occurs between a female MXM connector 206 and a corresponding male MXM interface of the graphics card 208.

The PCB 200 further includes a switch 210 arranged thereon. The switch 210 configures substantially equal bandwidth graphics busses 212 (depicted as a first graphics bus 212a, a second graphics bus 212b, and a third graphics bus 212c) with each of the graphics cards 208a-c via the corresponding MXM connectors 206a-c. Notably, due to the switch 210 performing multiplexing operations as supported by PCI-E standards, the PCI-E bus 204 may appear to be “over-distributed,” but in reality is not. For example, in one embodiment, such as depicted, the PCI-E bus 204 may be a 16 lane (x16) bus, and each of the three graphics busses 212a-c are an 8 lane (x8) bus.

While the PCI-E bus bandwidth (e.g., x2, x4, x8, x16, etc.) is determined based on the PCI-E slot of the motherboard 104 (FIG. 1) the graphics card adapter 112 is arranged in, the switch 210 can be programmed to generate a variety of quantity and bandwidth graphics busses 212a-c. In one embodiment (not shown), the PCB 200 may include sixteen (16) MXM connectors 206, and the switch 210 may generate sixteen (16) corresponding graphics busses 212, wherein each graphics bus is 4 lanes (x4). In further embodiments, such an exemplary switch 210 may be the PEX8747, manufactured by Avago Technologies of San Jose, Calif., USA. While the PEX8747 may be typically employed for converting a single x16 PCI-E bus to two x16 busses, it may alternatively be programmed as discussed herein.

In further embodiments, the switch also functions to enumerate the motherboard, thereby configuring how many graphics cards 208 the computer 102 detects and/or realizes and displays to the user. Thus, while there is only a single graphics card adapter 112, the computer 102 may display each graphics card 208a-c to the user as if the graphics cards 208a-c were arranged in individual PCI-E slots on the motherboard. Such is advantageous, for example, when running multiple virtualizations, as all graphics cards 208a-c need not be allocated to a single virtualization, but each graphics card 208a-c may be independently allocated to a separate virtualization.

In further embodiments, the graphics card adapter 112 further includes an system management BUS (SMBUS) chip 214 arranged thereon and configured to communicate SMBUS signals 216 (depicted as a first, second, and third SMBUS signal, 216a, 216b, and 216c, respectively) with each of the associated graphics cards 208a-c. The SMBUS signals 216a-c may include various signals transmitted to, and received from the graphics cards 208a-c. For example, in some embodiments, the SMBUS signals 216a-c may include receiving the status of each graphics card 208a-c, for example the graphics card 208a-c load level (idle, load speed, etc.) and/or the graphics card 208a-c temperature to monitor heat levels and assure the graphics card 208a-c does not overhead. Alternatively or in addition thereto, in further embodiments, the SMBUS signals 216a-c may also transmit a variety of signals to the graphics cards 208a-c, for example, a power on or power off signal or a reset signal. Those skilled in the art will appreciate the various number of additional signals not mentioned herein that may be transmitted between the SMBUS chip 214 and any or all of the graphics cards 208a-c.

In further embodiments, the graphics card adapter 112 may include one or more power input ports 218 (only one depicted). The power input port 218 enables powering any portion of the graphics card adapter 112 from an external source. Due to the limited power available via the PCI-E bus 202, external power is likely required to run one or more of the graphics cards 208a-c via the associated MXM connectors 206a-c. However, additional power may be required to run the other chips as well, such as the switch 210 and/or the SMBUS chip 214 and/or any other chip coupled to the PCB 200. While only one power input port 218 is depicted, it will be appreciated that additional power input ports may be included as necessary in other embodiments.

Similarly, in some embodiments, the graphics card adapter 112 may include one or more voltage regulators (VR) 220 (depicted as a first, second, third, and fourth voltage regulator, 220a, 220b, 220c, and 220d, respectively) coupled to the PCB 200 and electrically arranged between the power input port 218 and the MXM connectors 206a-c. Such voltage regulators 220a-d may be, for example and without limitation, one or a combination of 0.9 volt (V)/10 amp (A), 1.8V/0.7 A, 3.3V/6 A, and/or 5V/8 A regulators. As such, it will be appreciated that while four voltage regulators 220a-d are depicted, embodiments contemplated herein may include more or fewer voltage regulators 220a-d, including none if unnecessary.

Further embodiments of the graphics card adapter 112 include one or more display ports 222 (depicted as a first, second, and third display port, 222a, 222b, and 222c, respectively) coupled to the PCB 200. In one embodiment, the display ports 222a-c may each be coupled to a particular graphics card 208a-c, for example, the first display port 222a is only coupled to the first graphics card 208a via the first MXM connector 206a, the second display port 222b is only coupled to the second graphics card 208b via the second MXM connector 206b, and so forth. In other embodiments, there may be a single display port 222 capable of outputting the display from any of the graphics cards 208a-c via a hardware or software selection mechanism (not shown). In any event, the display ports 222a-c may be any type of display port capable of outputting the display from the graphics cards 208a-c known to those skilled in the art, for example, including but not limited to, a VGA style, s-video style, DVI style, HDMI style output or the like.

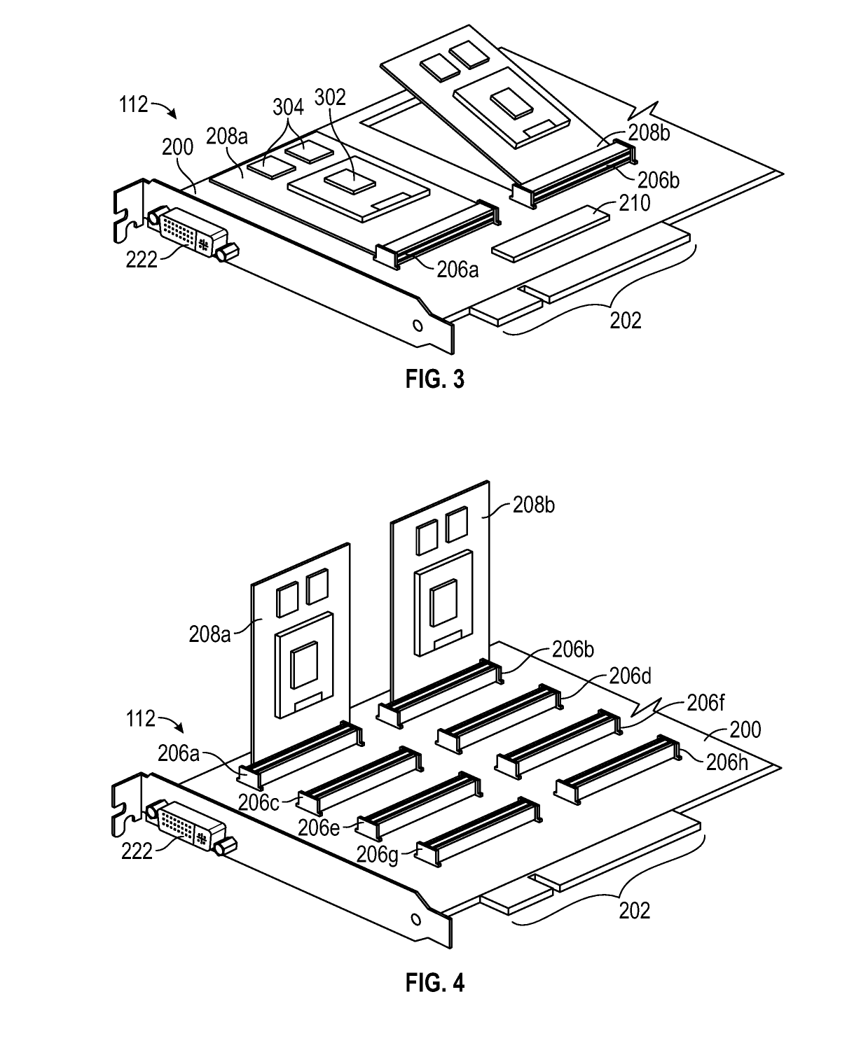

FIG. 3 depicts an angled view of the graphics card adapter 112 illustrating graphics cards 208 in various positions during the process of matingly engaging with the MXM connectors 206, according to one or more embodiments. More specifically, as depicted the MXM connectors 206 (only the first MXM connector 206a and second MXM connector 206b are depicted) are arranged such that when the graphics cards 208 are matingly engaged therewith, the graphics cards are arranged substantially parallel to the PCB 200. As discussed above, in some embodiments, as depicted, the graphics cards 208 typically include a graphics processing unit (GPU) 302 and memory 304.

As depicted, the first graphics card 208a is fully engaged with the first MXM connector 206a, and thus is substantially parallel to the PCB 200. For visualization purposes only, the second graphics card 208b represents a graphics card 208 in the process of being matingly engaged with the second MXM connector 206b, and thus is only partially engaged with the second MXM connector 206b. Upon the second graphics card 208b becoming fully engaged with the second MXM connector 206a, the second graphics card 208b will also be arranged substantially parallel to the PCB 200.

Such a layout, where the graphics cards 208 are arranged substantially parallel to the PCB 200 is advantageous due to enabling expansion of graphics processing, while still adhering to essentially the same form-factor as a typical graphics card and thus not requiring additional space on the motherboard 104 or within the chassis 103 (FIG. 1) than a typical graphics card.

FIG. 4 depicts a similar embodiment to FIG. 3. However, according to one embodiment, FIG. 4 illustrates an angled view of the graphics card adapter 112 having the plurality of MXM connectors 206a . . . n (206a-h depicted) arranged such that, when the graphics cards 208 are matingly engaged therewith, the graphics cards 208 are substantially perpendicular to the PCB 200. While such an embodiment requires more space within the chassis 103 (FIG. 1) than the embodiment depicted in FIG. 3, the additional number of graphics cards 208 that may be employed without requiring additional graphics cards adapters (or PCI-E connections on the motherboard 104 (FIG. 1) is advantageous.

The embodiments described herein present many advantages. For example, such embodiments enable increased graphics processing power while maintaining the form-factor and size of a typical graphics card. Moreover, such embodiments enable increasing graphics processing as necessary, whether it be upgrading graphics cards 208 employed or adding additional graphics cards 208 as needed (assuming fewer than all MXM connectors 206 are initially employed). Moreover, such embodiments are more power efficient than individual graphics card equivalent comparisons. In other words, for example, employing the graphics card adapter 112 with three graphics cards 208 is more power efficient than having three independent graphics cards of the computer 102. Similarly, employing the graphics card adapter 112 is cost effective due to the only additional purchase being the lower power graphics cards 208 instead of typical larger desktop or server graphics cards.

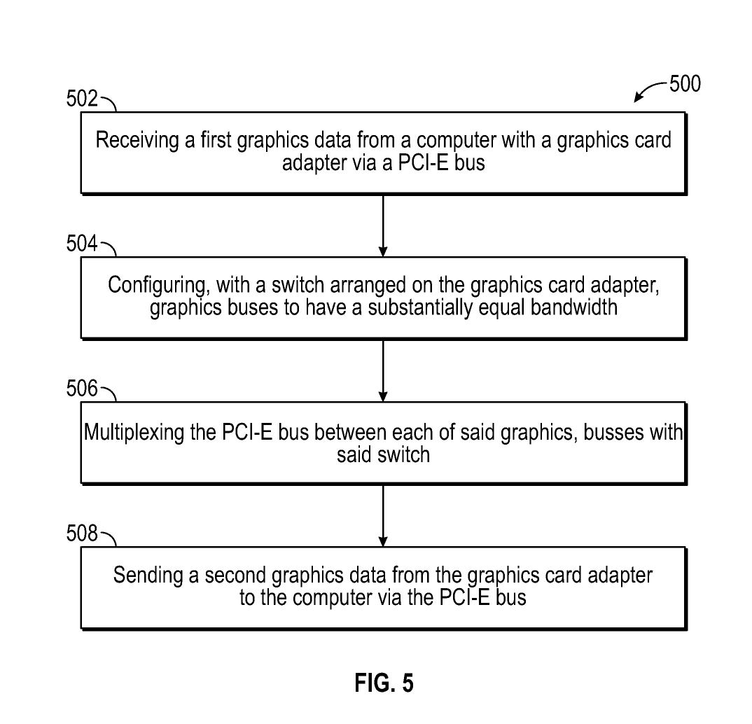

FIG. 5 is a flow diagram of an illustrative method 500 for processing graphics data via a graphics card adapter, according to one or more embodiments. At block 502, the method 500 receives a first graphics data from a computer, such as a desktop or any variety of server as known to those skilled in the art, with a graphics card adapter. Such transfer of graphics data is performed via a PCI-E bus of the computer (or a motherboard associated therewith).

The graphics card adapter is comprised of a printed circuit board (PCB) having a PCI-E interface for transferring graphics data with the computer via the PCI-E bus. The graphic card adapter further includes a plurality of MXM connectors coupled to the PCB for matingly engaging with graphics cards having a corresponding MXM interface. In one embodiment, the MXM connector may be a female MXM connector and the graphics card may have a corresponding male MXM connector for matingly engaging therewith.

Briefly, such a configuration is advantageous by enabling the use of multiple graphics cards arranged on the PCB via the MXM connectors, thus enabling the multiplexing and multi-threading of graphics processing of the graphics data. Moreover, graphics cards employing an MXM connector are typically in a small form-factor and use less power that general desktop graphics cards. Thus, the graphics adapter enables use of multiple graphics cards while only requiring a single PCI-E slot and bus on the computer motherboard, while also requiring less power than multiple full size graphics cards would otherwise. The graphics card adapter receives graphics data from the computer to be processed, performs such with the graphics cards, and then transmits the completed and processed graphics data back to the computer.

The graphics card further includes a switch arranged on the PCB which configures the graphics bus between the switch and each of the graphics cards via the corresponding MXM interface. As at block 504, the method 500 employs the switch to configure the graphics busses to have a substantially equal bandwidth. For example, in one embodiment, the graphics busses may each be configured as an 8 lane (x8) bus.

At block 506, advantageously, and as supported by PCI-E standards, the switch multiplexes the PCI-E bus between each of the graphics busses. In some embodiments, the PCI-E bus bandwidth can be any variety known to those skilled in the art (e.g., x2, x4, x8, x16, etc.). In one embodiment, for example, the PCI-E bus may be a 16 lane (x16) bus, and each of the three graphics busses are an 8 lane (x8) bus. While the PCI-E bus may appear to be “over-distributed,” in reality, it is not.

As discussed above, and as at block 508, once the graphics card(s) have completed processing the graphics data, a second (processed) graphics data is transmitted from the graphics card adapter to the computer via the PCI-E bus.

In further embodiments, the method 500 may include enabling power input to the graphics cards via one or more power input port(s) coupled to the PCB. Such may be advantageous if the number of graphics cards engaged in the MXM connectors requires more power than capable of being provided by the PCI-E bus alone. Similarly, in other embodiments, the method 500 may include regulating such power from the power input port(s) via one or more voltage regulators coupled to the PCB and electrically arranged between the power input port and the MXM connectors, thus being able to regular power to the corresponding graphics cards. Such voltage regulators may be, for example and without limitation, one or a combination of 0.9 volt (V)/10 amp (A), 1.8V/0.7 A, 3.3V/6 A, and/or 5V/8 A regulators.

Even further embodiments include where the second graphics are output or displayed via one or more display port(s) coupled to the PCB. The display port may be any type of display port capable of outputting the display from the graphics cards known to those skilled in the art, for example, including but not limited to, a VGA style, s-video style, DVI style, HDMI style output or the like. A single display port may be employed and capable of output the second (processed) graphics from one or more of the graphics cards. Alternatively, multiple display ports may be employed, for example where each display port outputs the graphics corresponds to only one of the graphics cards.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

Also, the terms in the claims have their plain, ordinary meaning unless otherwise explicitly and clearly defined by the patentee. Moreover, the articles “a” or “an,” as used in the claims, are defined herein to mean one or more than one of the element that it introduces. As used herein the term “and/or” and “/” includes any and all combinations of one or more of the associated listed items. While compositions and methods are described in terms of “comprising,” “containing,” or “including” various components or steps, the compositions and methods can also “consist essentially of” or “consist of” the various components and steps.

It will be understood that the sizes and relative orientations of the illustrated elements are not shown to scale, and in some instances they have been reduced or exaggerated for purposes of explanation. Additionally, if there is any conflict in the usages of a word or term in this specification and one or more patent or other documents that may be incorporated herein by reference, the definitions that are consistent with this specification should be adopted.

What is claimed is:

1. A graphics card adapter, comprising:
a printed circuit board (PCB) having a PCI Express (PCI-E) interface for transferring graphics information via a PCI-E bus;
a plurality of MXM connectors coupled to said PCB for matingly engaging with graphics cards having a corresponding MXM interface; and
a switch arranged on said PCB which configures a graphics bus between said switch and each of said graphics cards via said corresponding MXM interface, wherein each of said graphics bus is configured to have a substantially equal bandwidth, and wherein said switch multiplexes said PCI-E bus between each of said graphics busses.

2. The graphics card adapter of claim 1, wherein said MXM connector is arranged such that when said graphics cards are matingly engaged therewith, said graphics cards are arranged substantially parallel to said PCB.

3. The graphics card adapter of claim 1, wherein said MXM connector is arranged such that when said graphics cards are matingly engaged therewith, said graphics cards are substantially perpendicular to said PCB.

4. The graphics card adapter of claim 1, wherein said PCI-E interface is a sixteen lane (x16) interface.

5. The graphics card adapter of claim 4, wherein each of said graphics busses is eight lanes (x8).

6. The graphics card adapter of claim 4, wherein there are three (3) MXM connectors coupled to said PCB, and wherein said graphics bus to each MXM connector is eight lanes (x8).

7. The graphics card adapter of claim 4, wherein there are sixteen (16) MXM connectors coupled to said PCB, and wherein said graphics bus to each MXM connector is four lanes (x4).

8. The graphics card adapter of claim 1, further comprising a power input port coupled to said PCB, thereby enabling additional power input to one or more of said graphics cards.

9. The graphics card adapter of claim 8, further comprising voltage regulators coupled to said PCB and electrically arranged between said power input port and said MXM connectors.

10. The graphics card adapter of claim 1, further comprising a display output port coupled to said PCB.

11. The graphics cards adapter of claim 1, further comprising a plurality of display ports, wherein each display port corresponds to one of said plurality of said MXM connectors, thereby enabling video output from said corresponding video card.

12. A method for processing graphics data, comprising:
receiving a first graphics data from a computer with a graphics card adapter via a PCI Express (PCI-E) bus, said graphics card adapter being comprised of:
a printed circuit board (PCB) having a PCI-E interface for transferring graphics data via said PCI-E bus;
a plurality of MXM connectors coupled to said PCB for matingly engaging with graphics cards having a corresponding MXM interface;
a switch arranged on said PCB which configures a graphics bus between said switch and each of said graphics cards via said corresponding MXM interface;
configuring, with said switch, each of said graphics bus to have a substantially equal bandwidth;
multiplexing said PCI-E bus between each of said graphics busses with said switch; and
sending a second graphics data from the graphics card adapter to the computer via the PCI-E bus.

13. The method of claim 12, wherein said PCB PCI-E interface is a sixteen lane (x16) interface.

14. The method of claim 13, wherein said switch configures each of said graphics busses to be eight lanes (x8).

15. The method of claim 12, further comprising enabling power input to said graphics cards via a power input port coupled to said PCB.

16. The method of claim 15, further comprising regulating said power input to said graphics cards via a voltage regulator coupled to the PCB and electrically arranged between said power input port and said MXM connectors.

17. The method of claim 12, further comprising displaying at least a portion of said second graphics data via a display port coupled to said PCB.

18. A graphics data processing system, comprising:
a computer having a PCI-E bus for transmitting graphics data; and
a graphics card adapter coupled to said computer, said graphics card adapter comprising:
a printed circuit board (PCB) having a PCI Express (PCI-E) interface for transferring graphics information via said PCI-E bus;
a plurality of MXM connectors coupled to said PCB for matingly engaging with graphics cards having a corresponding MXM interface; and
a switch arranged on said PCB which configures a graphics bus between said switch and each of said graphics cards via said corresponding MXM interface, wherein each of said graphics bus is configured to have a substantially equal bandwidth, and wherein said switch multiplexes said PCI-E bus between each of said graphics busses.
